(19) United States
(12) Patent Application Publication
(10) Pub. No.: US 2024/0311764 A1
(43) Pub. Date: Sep. 19, 2024

(54) Collaborative Opportunity Injection Based on User Contribution Velocity

(71) Applicant: International Business Machines Corporation, Armonk, NY (US)

(72) Inventors: Logan Bailey, Atlanta, GA (US); Zachary A. Silverstein, Georgetown, TX (US); David M. Cesarano, Queen Creek, AZ (US); Jeremy R. Fox, Georgetown, TX (US)

(21) Appl. No.: 18/183,648

(22) Filed: Mar. 14, 2023

(51) Int. Cl. G06Q 10/10; G06Q 10/0631; G06Q 10/0639

(52) U.S. Cl. CPC G06Q 10/103; G06Q 10/063114; G06Q 10/06393

(57) ABSTRACT

Managing contribution velocity of users on tasks is provided. A current contribution velocity of a user on a task is determined based on monitoring current activity metrics corresponding to the user. It is determined whether the current contribution velocity of the user is less than a minimum contribution velocity threshold level defined for the task. In response determining that the current contribution velocity of the user is less than the minimum contribution velocity threshold level defined for the task, currently active co-collaborating users are identified based on monitored activity metrics on client devices of a set of co-collaborating users corresponding to the task. A collaboration is initiated between the currently active co-collaborating users and the user to assist the user on the task.

### BACKGROUND

The disclosure relates generally to task management and more specifically to managing contribution velocity of a user on a task by monitoring the contribution velocity of the user on the task and initiating a collaboration between active co-collaborating users corresponding to the task and the user to assist the user on the task when the contribution velocity falls below a defined minimum contribution velocity threshold level.

With the growing trend of working remotely, teams need to communicate, collaborate, and share work product and ideas quickly. A collaborative environment is where a task or project is worked on by multiple people regardless of their geographic location. As a result, a collaborative environment is often virtual and utilizes technologies, such as, for example, email, instant messaging, video conferencing, application sharing, collaborative workspaces, Wiki groups, blogging, and the like. In addition, working in a collaborative environment can facilitate completion of tasks in less time. For example, collaboration enables a group of people to constructively explore different ideas to discover solutions to tasks that are far more extensive than only one person's thought process.

### SUMMARY

According to one illustrative embodiment, a computer-implemented method for managing contribution velocity of users on tasks is provided. A computer determines a current contribution velocity of a user on a task based on monitoring current activity metrics corresponding to the user. The computer determines whether the current contribution velocity of the user is less than a minimum contribution velocity threshold level defined for the task. In response to the computer determining that the current contribution velocity of the user is less than the minimum contribution velocity threshold level defined for the task, the computer identifies currently active co-collaborating users based on monitored activity metrics on client devices of a set of co-collaborating users corresponding to the task. The computer initiates a collaboration between the currently active co-collaborating users and the user to assist the user on the task. According to other illustrative embodiments, a computer system and computer program product for managing contribution velocity of users on tasks are provided.

### BRIEF DESCRIPTION OF THE DRAWINGS

FIG. 1 is a pictorial representation of a computing environment in which illustrative embodiments may be implemented;

FIG. 2 is a diagram illustrating an example of a contribution velocity management process in accordance with an illustrative embodiment; and

FIGS. 3A-3B are a flowchart illustrating a process for managing contribution velocity of users on tasks in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

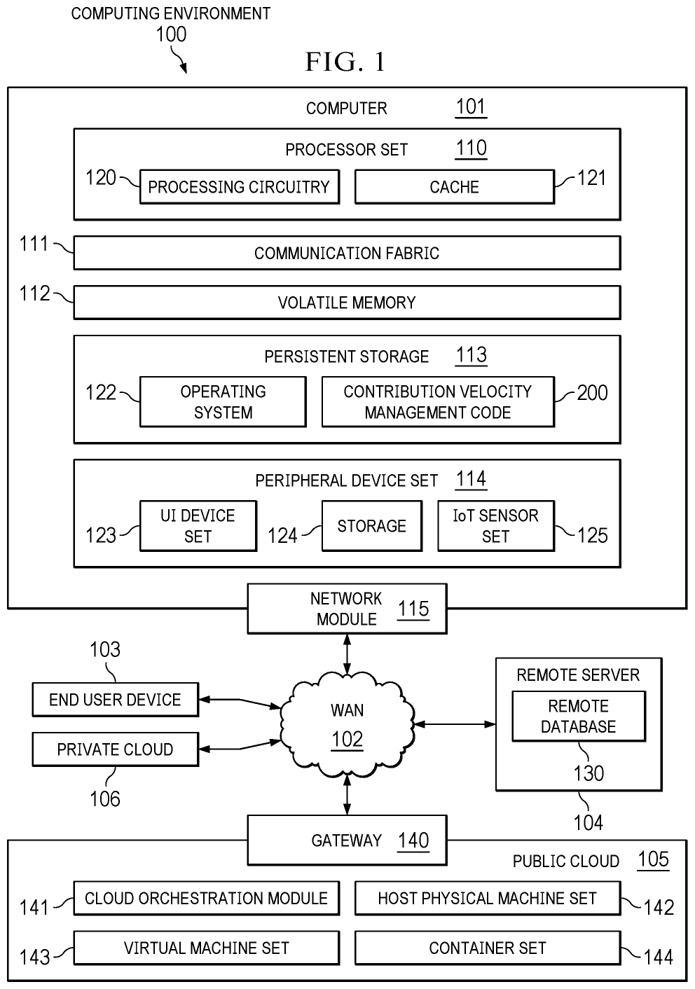

With reference now to the figures, and in particular, with reference to FIG. 1, a diagram of a computing environment is provided in which illustrative embodiments may be implemented. It should be appreciated that FIG. 1 is only meant as an example and is not intended to assert or imply any limitation with regard to the computing environments in which different embodiments may be implemented. Many modifications to the depicted computing environment may be made.

Computing environment 100 contains an example of an environment for the execution of at least some of the computer code involved in performing the inventive methods, such as contribution velocity management code 200. For example, contribution velocity management code 200 monitors the contribution velocity of a user on a task (e.g., project, assignment, job, or the like) and any currently active applications (e.g., open displays or windows) on the user's client device (e.g., desktop computer, laptop computer, tablet computer, smart phone, or the like) to gauge the current speed or rate of progress (i.e., contribution velocity) on the task by the user. In addition, contribution velocity management code 200 initiates a collaboration between other active co-collaborating users corresponding to that task and the user to assist the user on the task in response to contribution velocity management code 200 determining that the user's contribution velocity on that task has fallen below a minimum contribution velocity threshold level defined for that task. In other words, contribution velocity management code 200 determines whether or not the user is currently active and working on that task or at a low contribution velocity for that task based on the type of application the user is currently utilizing or viewing on the user's client device. For example, contribution velocity management code 200 determines whether the user is currently utilizing an application that corresponds to that task. Further, contribution velocity management code 200 can identify an alternate task for the user to start working on in response to contribution velocity management code 200 determining that no other co-collaborating user on that task is currently active and one or more other users who are collaborating on the alternate task, which also corresponds to the user, are currently active.

In addition to contribution velocity management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and contribution velocity management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in contribution velocity management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The contribution velocity management code included in block 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (for example, a user of the contribution velocity management services provided by computer 101), and may take any of the forms discussed above in connection with computer 101. EUD 103 typically receives helpful and useful data from the operations of computer 101. For example, in a hypothetical case where computer 101 is designed to provide a contribution velocity acceleration recommendation to the end user, this contribution velocity acceleration recommendation would typically be communicated from network module 115 of computer 101 through WAN 102 to EUD 103. In this way, EUD 103 can display, or otherwise present, the contribution velocity acceleration recommendation to the end user. In some embodiments, EUD 103 may be a client device, such as thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a contribution velocity acceleration recommendation based on historical data, then this contribution velocity acceleration historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

One of the best ways for progress to be made on a task is to work on the task collaboratively with others. However, one issue with working on a task collaboratively is that each of the collaborating users may not know what other collaborating users are currently doing. In addition, one or more of the collaborating users on the task may become disinterested, distracted, diverted, detached, unfocused, or the like. Consequently, a solution is needed that can identify a decreased contribution velocity of a user on a task and notify other co-collaborating users to reach out to the user to assist the user on the task when needed. In other words, a solution is needed that can identify who to notify to collaborate with the user regarding the task to align the contribution velocity of co-collaborating users when the user's current level of contribution is low.

Illustrative embodiments dynamically inject a collaborative notification based on the contribution velocity of a user on a particular task. For example, illustrative embodiments monitor the contribution velocity of the user on that particular task and the currently active application on the user's computer to gauge the current rate of contribution of the user on that particular task. Illustrative embodiments notify other active co-collaborating users corresponding to that particular task in response to illustrative embodiments determining that the current contribution velocity of the user is less than or equal to a defined minimum contribution velocity threshold level for that particular task. For example, illustrative embodiments determine that the user's current rate of progress on writing a particular document (i.e., the current task) is slowing down based on illustrative embodiments monitoring the activity metrics corresponding to the user. Activity metrics are indicators that a collaborating user is currently working on a task. Activity metrics can include, for example, the currently active application that the user is utilizing on the user's computer (i.e., client device) to perform the task, current inputs (e.g., keystrokes on the keyboard, menu selects, and the like) on the user's computer related to the task, unrelated application interactions or other unrelated computer activity on the user's computer, and the like.

In response to illustrative embodiments determining that the contribution velocity of the user on the document has fallen below the defined minimum contribution velocity threshold level, illustrative embodiments determine whether one or more other co-collaborating users on the document are currently active. In response to illustrative embodiments determining that one or more of the other co-collaborating users on the document are currently active, illustrative embodiments initiate a collaboration between those other active co-collaborating users and the user to assist the user on the document. Illustrative embodiments also monitor the activity metrics of the other co-collaborating users to determine when any of the other co-collaborating users are currently active. Illustrative embodiments notify those currently active co-collaborating users when the user's contribution velocity is below the defined minimum contribution velocity threshold level so that those other currently active co-collaborating users can encourage and assist the user on the document. Activity metrics can also indicate when a particular co-collaborating user is currently available (e.g., currently online, not participating in a scheduled meeting, and the like).

Furthermore, in response to illustrative embodiments determining that none of the other co-collaborating users on the document are currently active when the contribution velocity of the user is below the defined minimum contribution velocity threshold level, illustrative embodiments direct the user to work on an alternate task, which also corresponds to the user, that has one or more currently active users who are collaborating with the user on the alternate task. In addition, illustrative embodiments take into account whether a particular co-collaborating user has historically communicated with other co-collaborating users when notified by illustrative embodiments and how effective that particular co-collaborating user has been with regard to assisting other co-collaborating users with tasks.

Moreover, illustrative embodiments take into account historic contribution velocity acceleration on a given task when the original co-collaborating users request one or more additional users to collaboratively work with the original co-collaborating users on that same task. As an illustrative example scenario, two co-collaborating users, User 1 and User 2, have reached a point where the two co-collaborating users are ready for additional input on a particular task. Thus, the two co-collaborating users invite another user, User 3, who is currently online and ready to assist with that particular task. User 3 wants to collaborate with User 1 and User 2, but User 3 also wants User 4, who is an expert on the topic of that particular task and who is currently online, to join the collaborative effort. It should be noted that a dynamic “chaining” effect exists when additional users are asked to collaborate with the original co-collaborating users on a task in real-time. This addition of other users reinforces the ability to accelerate movement toward completion of the task in real-time based on a set of specific parameters or criteria. For example, the set of specific parameters may include a maximum number of collaborating users and a specified time limit on the task, such as a maximum of eight collaborating users and a twenty-four-hour time limit on the task. As a result, this dynamic chaining effect yields higher contribution velocity on the task.

Thus, illustrative embodiments provide one or more technical solutions that overcome a technical problem with an inability of collaborating users to know whether other collaborating users need assistance on that task. As a result, these one or more technical solutions provide a technical effect and practical application in the field of task management.

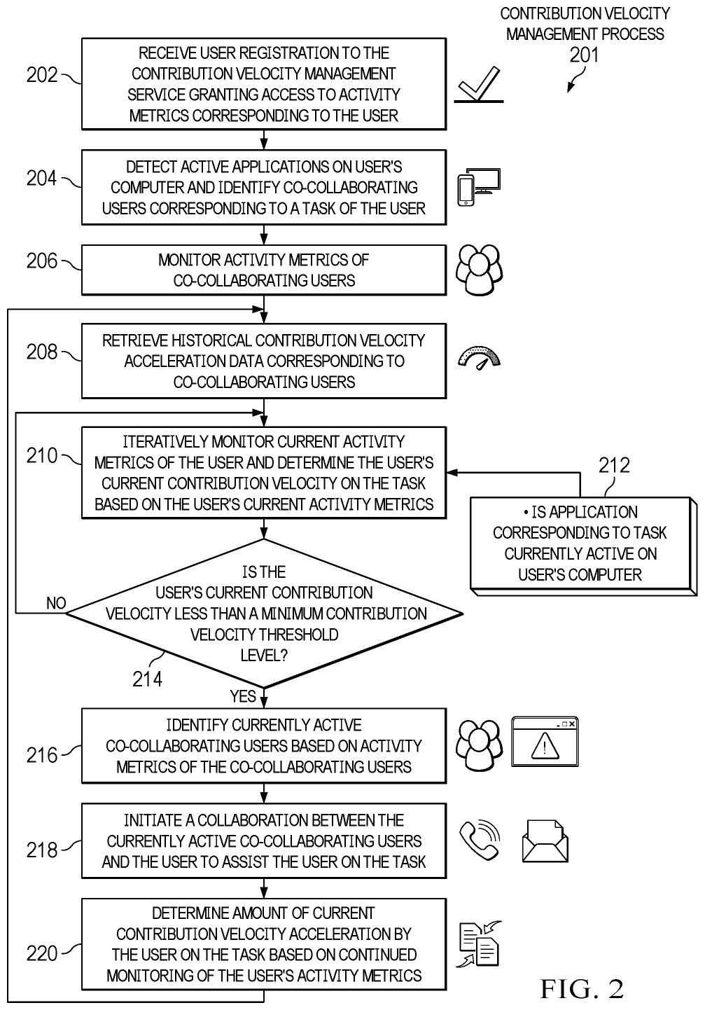

With reference now to FIG. 2, a diagram illustrating an example of a contribution velocity management process is depicted in accordance with an illustrative embodiment. Contribution velocity management process 201 may be implemented in a computer, such as, for example, computer 101 in FIG. 1. For example, contribution velocity management process 201 may be implemented in contribution velocity management code 200 in FIG. 1.

At 202, the computer, which provides the contribution velocity management services of illustrative embodiments, receives a user registration to the contribution velocity management services granting access to activity metrics corresponding to the user from the user's computer via a network. It should be noted that the user's computer is a client device of the computer. At 204, the computer detects active applications on the user's computer and identifies co-collaborating users corresponding to a task of the user.

At 206, the computer monitors activity metrics of the co-collaborating users. At 208, the computer retrieves historical contribution velocity acceleration data corresponding to the co-collaborating users from storage. At 210, the computer iteratively monitors current activity metrics 212 of the user on a predetermined time interval basis (e.g., once every minute, five minutes, ten minutes, thirty minutes, sixty minutes, or any other interval of time) and determines the user's current contribution velocity on the task based on current activity metrics 212 of the user. Current activity metrics 212 include, for example, at least one of the computer identifying whether the application corresponding to the task is currently active on the user's computer, the computer identifying current inputs related to the task on the user's computer, the computer identifying any unrelated application interactions and unrelated computer activity on the user's computer, and the like. It should be noted that the computer increases the user's current contribution velocity for the task in response to the computer identifying that the application corresponding to the task is currently active on the user's computer. Conversely, the computer deceases the user's current contribution velocity for the task in response to the computer identifying that the application corresponding to the task is not currently active on the user's computer.

At 214, the computer determines whether the user's current contribution velocity is less than a minimum contribution velocity threshold level defined for the task. In response to the computer determining that the user's current contribution velocity is not less than the minimum contribution velocity threshold level defined for the task, the computer, at 210, continues to iteratively monitor current activity metrics 212. In response to the computer determining that the user's current contribution velocity is less than the minimum contribution velocity threshold level defined for the task, the computer, at 216, identifies currently active co-collaborating users based on the activity metrics of the co-collaborating users.

At 218, the computer initiates a collaboration between the currently active co-collaborating users and the user to assist the user on the task. For example, the currently active co-collaborating users can engage the user in a collaborative session to assist the user on the task to increase the user's current contribution velocity. At 220, the computer determines an amount of current contribution velocity acceleration by the user on the task based on continued monitoring of the user's activity metrics. In addition, the computer stores the amount of current contribution velocity acceleration in the historical contribution velocity acceleration data.

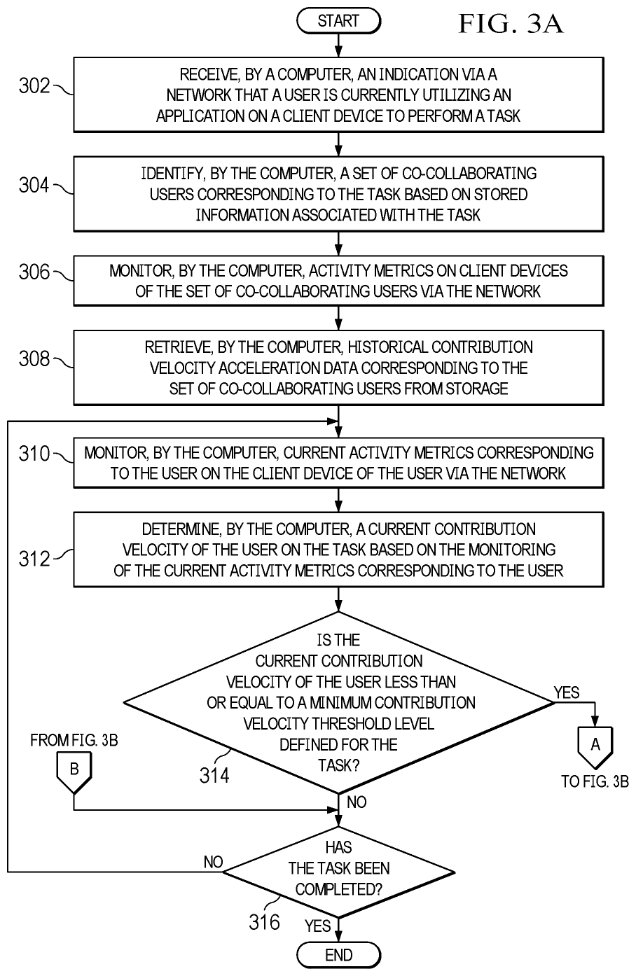

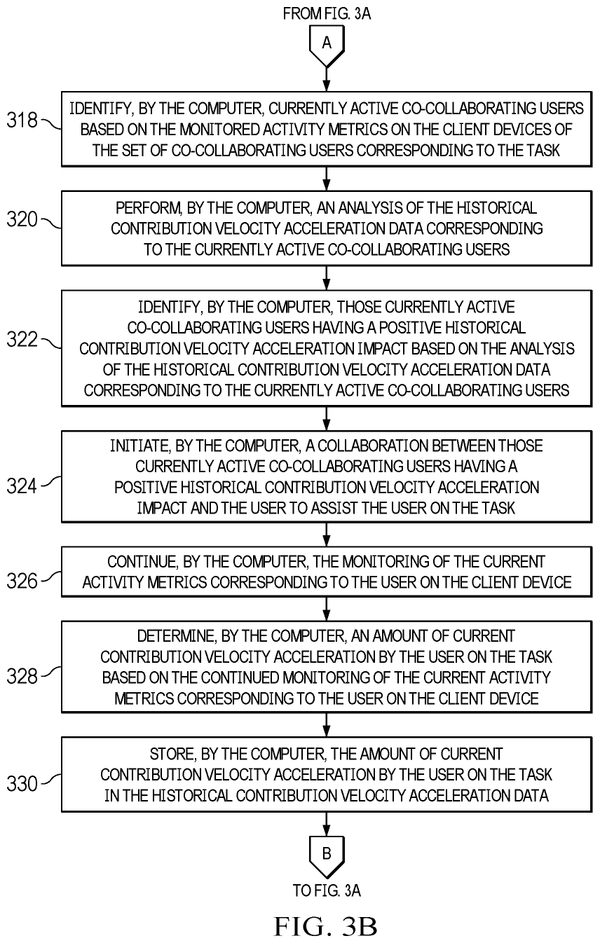

With reference now to FIGS. 3A-3B, a flowchart illustrating a process for managing contribution velocity of users on tasks is shown in accordance with an illustrative embodiment. The process shown in FIGS. 3A-3B may be implemented in a computer, such as, for example, computer 101 in FIG. 1. For example, the process shown in FIGS. 3A-3B may be implemented in contribution velocity management code 200 in FIG. 1.

The process begins when the computer receives an indication via a network that a user is currently utilizing an application on a client device to perform a task (step 302). In response to receiving the indication, the computer identifies a set of co-collaborating users corresponding to the task based on stored information associated with the task (step 304). In addition, the computer monitors activity metrics on client devices of the set of co-collaborating users via the network (step 306). The computer also retrieves historical contribution velocity acceleration data corresponding to the set of co-collaborating users from storage (step 308).

Further, the computer monitors current activity metrics corresponding to the user on the client device of the user via the network (step 310). Furthermore, the computer determines a current contribution velocity of the user on the task based on the monitoring of the current activity metrics corresponding to the user (step 312). Afterward, the computer makes a determination as to whether the current contribution velocity of the user is less than or equal to a minimum contribution velocity threshold level defined for the task (step 314).

If the computer determines that the current contribution velocity of the user is greater than the minimum contribution velocity threshold level defined for the task, no output of step 314, then the computer makes a determination as to whether the task has been completed (step 316). If the computer determines that the task has not been completed, no output of step 316, then the process returns to step 310 where the computer continues to monitor the current activity metrics corresponding to the user. If the computer determines that the task has been completed, yes output of step 316, then the process terminates thereafter.

Returning again to step 314, if the computer determines that the current contribution velocity of the user is less than or equal to the minimum contribution velocity threshold level defined for the task, yes output of step 314, then the computer identifies currently active co-collaborating users based on the monitored activity metrics on the client devices of the set of co-collaborating users corresponding to the task (step 318). The computer performs an analysis of the historical contribution velocity acceleration data corresponding to the currently active co-collaborating users (step 320). The computer identifies those currently active co-collaborating users having a positive historical contribution velocity acceleration impact based on the analysis of the historical contribution velocity acceleration data corresponding to the currently active co-collaborating users (step 322). The positive historical contribution velocity acceleration impact indicates that those currently active co-collaborating users were previously able to assist one or more other users on one or more other tasks.

The computer initiates a collaboration between those currently active co-collaborating users having a positive historical contribution velocity acceleration impact and the user to assist the user on the task (step 324). The computer continues the monitoring of the current activity metrics corresponding to the user on the client device (step 326). The computer determines an amount of current contribution velocity acceleration by the user on the task based on the continued monitoring of the current activity metrics corresponding to the user on the client device (step 328). Subsequently, the computer stores the amount of current contribution velocity acceleration by the user on the task in the historical contribution velocity acceleration data (step 330). Thereafter, the process returns to step 316 where the computer determines whether the task has been completed or not.

Thus, illustrative embodiments of the present invention provide a computer-implemented method, computer system, and computer program product for managing contribution velocity of users on tasks. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing contribution velocity of users on tasks, the computer-implemented method comprising:
determining, by a computer, a current contribution velocity of a user on a task based on monitoring current activity metrics corresponding to the user;
determining, by the computer, whether the current contribution velocity of the user is less than a minimum contribution velocity threshold level defined for the task;
responsive to the computer determining that the current contribution velocity of the user is less than the minimum contribution velocity threshold level defined for the task, identifying, by the computer, currently active co-collaborating users based on monitored activity metrics on client devices of a set of co-collaborating users corresponding to the task; and
initiating, by the computer, a collaboration between the currently active co-collaborating users and the user to assist the user on the task.

2. The computer-implemented method of claim 1, further comprising:
responsive to determining that none of the set of co-collaborating users corresponding to the task are currently active when the current contribution velocity of the user is less than the minimum contribution velocity threshold level defined for the task, directing, by the computer, the user to work on an alternate task that has one or more currently active users who are collaborating with the user on the alternate task.

3. The computer-implemented method of claim 1, further comprising:
retrieving, by the computer, historical contribution velocity acceleration data corresponding to the set of co-collaborating users;
performing, by the computer, an analysis of the historical contribution velocity acceleration data corresponding to the currently active co-collaborating users of the set of co-collaborating users;
identifying, by the computer, those currently active co-collaborating users having a positive historical contribution velocity acceleration impact based on the analysis of the historical contribution velocity acceleration data corresponding to the currently active co-collaborating users; and
initiating, by the computer, the collaboration between those currently active co-collaborating users having the positive historical contribution velocity acceleration impact and the user to assist the user on the task.

4. The computer-implemented method of claim 3, wherein the positive historical contribution velocity acceleration impact indicates that those currently active co-collaborating users were previously able to assist one or more other users on one or more other tasks.

5. The computer-implemented method of claim 1, further comprising:
receiving, by the computer, an indication via a network that the user is currently utilizing an application on a client device to perform the task;
identifying, by the computer, the set of co-collaborating users corresponding to the task based on stored information associated with the task;
monitoring, by the computer, activity metrics on the client devices of the set of co-collaborating users via the network to form the monitored activity metrics; and
monitoring, by the computer, the current activity metrics corresponding to the user on the client device of the user via the network.

6. The computer-implemented method of claim 1, further comprising:
continuing, by the computer, to monitor the current activity metrics corresponding to the user;
determining, by the computer, an amount of current contribution velocity acceleration by the user on the task based on continued monitoring of the current activity metrics corresponding to the user; and
storing, by the computer, the amount of current contribution velocity acceleration by the user on the task in historical contribution velocity acceleration data.

7. The computer-implemented method of claim 1, wherein the current activity metrics corresponding to the user include the computer identifying whether an application corresponding to the task is currently active on a client device of the user, and wherein the computer increases the current contribution velocity of the user for the task in response to the computer identifying that the application corresponding to the task is currently active on the client device of the user, and wherein the computer deceases the current contribution velocity of the user for the task in response to the computer identifying that the application corresponding to the task is not currently active on the client device of the user.

8. A computer system for managing contribution velocity of users on tasks, the computer system comprising:
a communication fabric;
a storage device connected to the communication fabric, wherein the storage device stores program instructions; and
a processor connected to the communication fabric, wherein the processor executes the program instructions to:
determine a current contribution velocity of a user on a task based on monitoring current activity metrics corresponding to the user;
determine whether the current contribution velocity of the user is less than a minimum contribution velocity threshold level defined for the task;
identify currently active co-collaborating users based on monitored activity metrics on client devices of a set of co-collaborating users corresponding to the task in response to determining that the current contribution velocity of the user is less than the minimum contribution velocity threshold level defined for the task; and
initiate a collaboration between the currently active co-collaborating users and the user to assist the user on the task.

9. The computer system of claim 8, wherein the processor further executes the program instructions to:
direct the user to work on an alternate task that has one or more currently active users who are collaborating with the user on the alternate task in response to determining that none of the set of co-collaborating users corresponding to the task are currently active when the current contribution velocity of the user is less than the minimum contribution velocity threshold level defined for the task.

10. The computer system of claim 8, wherein the processor further executes the program instructions to:
retrieve historical contribution velocity acceleration data corresponding to the set of co-collaborating users;
perform an analysis of the historical contribution velocity acceleration data corresponding to the currently active co-collaborating users of the set of co-collaborating users;
identify those currently active co-collaborating users having a positive historical contribution velocity acceleration impact based on the analysis of the historical contribution velocity acceleration data corresponding to the currently active co-collaborating users; and
initiate the collaboration between those currently active co-collaborating users having the positive historical contribution velocity acceleration impact and the user to assist the user on the task.

11. The computer system of claim 10, wherein the positive historical contribution velocity acceleration impact indicates that those currently active co-collaborating users were previously able to assist one or more other users on one or more other tasks.

12. The computer system of claim 8, wherein the processor further executes the program instructions to:
receive an indication via a network that the user is currently utilizing an application on a client device to perform the task;
identify the set of co-collaborating users corresponding to the task based on stored information associated with the task;
monitor activity metrics on the client devices of the set of co-collaborating users via the network to form the monitored activity metrics; and
monitor the current activity metrics corresponding to the user on the client device of the user via the network.

13. The computer system of claim 8, wherein the processor further executes the program instructions to:
continue to monitor the current activity metrics corresponding to the user;
determine an amount of current contribution velocity acceleration by the user on the task based on continued monitoring of the current activity metrics corresponding to the user; and
store the amount of current contribution velocity acceleration by the user on the task in historical contribution velocity acceleration data.

14. A computer program product for managing contribution velocity of users on tasks, the computer program product comprising a computer-readable storage medium having program instructions embodied therewith, the program instructions executable by a computer to cause the computer to perform a method of:
determining, by the computer, a current contribution velocity of a user on a task based on monitoring current activity metrics corresponding to the user;
determining, by the computer, whether the current contribution velocity of the user is less than a minimum contribution velocity threshold level defined for the task;
responsive to the computer determining that the current contribution velocity of the user is less than the minimum contribution velocity threshold level defined for the task, identifying, by the computer, currently active co-collaborating users based on monitored activity metrics on client devices of a set of co-collaborating users corresponding to the task; and
initiating, by the computer, a collaboration between the currently active co-collaborating users and the user to assist the user on the task.

15. The computer program product of claim 14, further comprising:
responsive to determining that none of the set of co-collaborating users corresponding to the task are currently active when the current contribution velocity of the user is less than the minimum contribution velocity threshold level defined for the task, directing, by the computer, the user to work on an alternate task that has one or more currently active users who are collaborating with the user on the alternate task.

16. The computer program product of claim 14, further comprising:
retrieving, by the computer, historical contribution velocity acceleration data corresponding to the set of co-collaborating users;
performing, by the computer, an analysis of the historical contribution velocity acceleration data corresponding to the currently active co-collaborating users of the set of co-collaborating users;
identifying, by the computer, those currently active co-collaborating users having a positive historical contribution velocity acceleration impact based on the analysis of the historical contribution velocity acceleration data corresponding to the currently active co-collaborating users; and
initiating, by the computer, the collaboration between those currently active co-collaborating users having the positive historical contribution velocity acceleration impact and the user to assist the user on the task.

17. The computer program product of claim 16, wherein the positive historical contribution velocity acceleration impact indicates that those currently active co-collaborating users were previously able to assist one or more other users on one or more other tasks.

18. The computer program product of claim 14, further comprising:
receiving, by the computer, an indication via a network that the user is currently utilizing an application on a client device to perform the task;
identifying, by the computer, the set of co-collaborating users corresponding to the task based on stored information associated with the task;
monitoring, by the computer, activity metrics on the client devices of the set of co-collaborating users via the network to form the monitored activity metrics on the client devices of the set of co-collaborating users corresponding to the task; and
monitoring, by the computer, the current activity metrics corresponding to the user on the client device of the user via the network.

19. The computer program product of claim 14, further comprising:
continuing, by the computer, to monitor the current activity metrics corresponding to the user;
determining, by the computer, an amount of current contribution velocity acceleration by the user on the task based on continued monitoring of the current activity metrics corresponding to the user; and
storing, by the computer, the amount of current contribution velocity acceleration by the user on the task in historical contribution velocity acceleration data.

20. The computer program product of claim 14, wherein the current activity metrics corresponding to the user include the computer identifying whether an application corresponding to the task is currently active on a client device of the user, and wherein the computer increases the current contribution velocity of the user for the task in response to the computer identifying that the application corresponding to the task is currently active on the client device of the user, and wherein the computer deceases the current contribution velocity of the user for the task in response to the computer identifying that the application corresponding to the task is not currently active on the client device of the user.
